(19) United States
(12) Patent Application Publication
(10) Pub. No.: US 2003/0090221 A1
(43) Pub. Date: May 15, 2003

(54) Electromechanical adjusting unit for a transmission

(76) Inventors: Ingo Becker, Linnich (DE); Frank Franzen, Bad Abbach (DE); Joachim Gilly, Estenfeld (DE); Frank Kirschke-Biller, Wermelskirchen (DE); Karl Smirra, Wasserburg (DE); Michael Ulm, Alteglofsheim (DE)

Correspondence Address: Bruce W. Slayden II, Baker Botts LLP, 910 Louisiana, Houston, TX, 77002-4995, US

(21) Appl. No.: 10/230,479

(22) Filed: Aug. 29, 2002

Related U.S. Application Data
(63) Continuation of application No. PCT/DE01/00745, filed on Feb. 28, 2001.

(30) Foreign Application Priority Data
Mar. 3, 2000 (DE) 10010636.6

(51) Int. Cl. H02P 7/06

(52) U.S. Cl. 318/254

(57) ABSTRACT

The unit includes an electro-mechanical drive (1), and an adjustment gearing (6) with a mechanical output (12) for influencing the switching positions of the distributor gearing, which is driven by the electro-mechanical drive. A circuit carrier (13) is provided, on which an electronic circuit (14) for controlling the electro-mechanical drive is realised. A sensor device (16), preferably mounted on the circuit carrier, is connected with the electronic circuit for detecting a movement of the adjustment gearing. Commutator contacts (15) for the electro-mechanical drive are preferably mounted at the circuit carrier.

### BACKGROUND OF THE INVENTION

The invention relates to an electromechanical adjusting unit for setting the shift positions of a transmission, in particular a motor vehicle transmission or a power divider.

In addition to front wheel or rear wheel drive vehicles, all wheel drive motor vehicles are increasingly also being produced in the automobile industry. Whereas the drive train for front wheel or rear wheel drive motor vehicles manages with an engine and a transmission connected downstream, a so-called power divider is also connected downstream of this drive train in the case of all wheel drive vehicles. Power dividers have the task of dividing the total propulsive power produced in the engine of the vehicle as a function of the driver's gear selection or of an automatic shift algorithm into two partial propulsive powers for the front and rear axles (or else into four partial propulsive powers for the four wheels) of the motor vehicle. The rotating drive shaft of the vehicle transmission serves in this case as input shaft of the power divider.

In order to divide the input power, it is necessary to implement different shift positions mechanically in the power divider. For this purpose, the power divider includes a shift position mechanism which, for its part, is actuated by an electromechanical adjusting unit fastened on the power divider. The adjusting unit usually comprises an electric motor and an actuating gear. If the motor vehicle driver actuates the selector lever for a desired shift position of the power divider (for example 4H: 4-wheel drive), the electric motor is fed an excitation current which causes a rotation of the motor shaft, an adjustment, effected thereby, of the mechanical output of the actuating gear and—by actuating the shift position mechanism internal to the transmission—the transition of the power divider into the desired shift position.

Known electromechanical adjusting units frequently have the disadvantage that the electric motor is driven by a remotely arranged electronic control system and, owing to the required cable connections, this entails cost disadvantages and, moreover, functional restrictions, including functional safety, occasionally. Furthermore, previously known adjusting units do not have an integrated sensor system.

### SUMMARY OF THE INVENTION

It is the object of the invention to create an electromechanical adjusting unit for setting the shift positions of a transmission, the design of which adjusting unit renders possible a high degree of functionality and potential for cost savings. In particular, the adjusting unit is intended to offer a high degree of integration with reference to mechanical, electromechanical and electronic components.

A first embodiment is an electromechanical adjusting unit for setting the shift positions of a transmission, which comprises an electromechanical drive, an actuating gear, driven by the electromechanical drive, with a mechanical output for influencing the shift positions of the transmission, a circuit support on which an electronic circuit is implemented for controlling the electromechanical drive, and a sensor means, electrically connected to the electronic circuit, for detecting a movement variable of the actuating gear, wherein the actuating gear is a worm gear, and wherein the circuit support extends substantially parallel to the center plane of a worm wheel of the worm gear.

Another embodiment is an electromechanical adjusting unit for setting the shift positions of a transmission, which comprises an electromechanical drive, an actuating gear, driven by the electromechanical drive, with a mechanical output for influencing the shift positions of the transmission, a circuit support on which an electronic circuit is implemented for controlling the electromechanical drive, and a sensor means, electrically connected to the electronic circuit, for detecting a movement variable of the actuating gear, wherein the commutator contacts for the electromechanical drive are mounted on the circuit support.

By integrating the circuit support, with the electronic circuit arranged thereon, and the sensor means into the adjusting unit, an arrangement is created that already includes all components required for controlling the adjusting drive, and therefore manages with a minimum of contact plugs and cable sets for connection to the electrical vehicle periphery. In addition to the cost advantages, which such an integrated design offers by comparison with a “distributed” solution, the combination of electronic and sensor systems in one unit creates a high design variability of the overall electronic/sensor system that cannot be achieved, or can be achieved only with a high cabling outlay, in the case of an adjusting unit with remotely arranged electronic control and/or sensor system mounted outside. As a result, the functionality of the adjusting unit is intensified and the operational reliability of the unit is favorably influenced.

A particularly compact design from the point of view of circuitry is achieved when the sensor means is applied directly to the circuit support, which carries the electronic circuit, and electrical contact is made with it. This refinement also offers advantages from the point of view of electromagnetic compatibility (EMC).

In addition to the sensor means, it is also advantageously possible to arrange further components on the circuit support and for them to make electric contact with it. In particular, the commutator contacts for the electromechanical drive and/or a receptacle for integrating the electromechanical adjusting unit in an electrical motor vehicle periphery can be mounted on the circuit support. It is also possible, moreover, to fit on the circuit support an H-bridge motor drive for the electromechanical drive, movement or absolute angle detection sensors based on Hall-ICs or GMR (giant magneto resistance) components, a current sampling unit, etc.

A worm gear, for example, can be used as actuating gear. An advantageous arrangement of the circuit support is characterized in this case in that the circuit support extends substantially parallel to the center plane of the worm wheel of the worm gear. A space saving accommodation of the circuit support in the design volume of the unit is thereby achieved. The interrelationship of electronic extent (circuit support with electronic circuit and, if appropriate, sensor system) and mechanical extent (actuating gear, electromechanical drive) also has the advantage that these two extents run adjacently over wide areas, so that it is virtually always possible to find a suitable location on the circuit support for fitting the sensor system. A further advantage of such a circuit support placement consists in that said support can easily be coupled over a large area to a cooling body or other suitable heat sinks.

In accordance with a first preferred possibility, the circuit support is dimensioned such that it covers exclusively an edge region of the worm wheel, and that a first sensor, in particular a Hall sensor, is fitted on the circuit support in this region in order to detect a rotary movement of the worm wheel. It is thus possible to implement an incremental determination of rotational angle.

In the case of a further possibility for dimensioning the circuit support, the latter covers the center of the worm wheel, and there is located in a region neighboring the worm wheel center a second sensor, in particular a GMR sensor, fitted on the circuit support, which is suitable for detecting an absolute rotational angle position of the worm wheel.

In the case of both possibilities, the circuit support can be tailored such that it covers that end of a worm shaft of the worm gear which is remote from the drive, there being fitted on the circuit support in this region a third sensor, in particular a GMR sensor, for determining a rotational speed of the worm shaft.

To provide protection against contamination, the unit is expediently configured such that the circuit support is accommodated in a housing space partitioned off from the actuating gear.

The circuit support is preferably a rigid printed circuit board, but it is possible, depending on the concrete application, also to use rigid/flexible printed circuit boards or, if appropriate, completely flexible printed circuit boards as circuit supports.

The invention is particularly suitable for use in transmissions of motor vehicles and, very particularly, for a power divider that divides the power produced in the vehicle engine between the front and rear axles of an all wheel drive vehicle.

### BRIEF DESCRIPTION OF THE DRAWINGS

The invention is described in more detail below with the aid of two exemplary embodiments and variants of the same, reference being made to the drawing, identical or similar parts being marked with the same reference numerals in the figures of the drawing, in which:

FIG. 1 shows a schematic, partially cut away rear view of an adjusting unit in accordance with a first exemplary embodiment of the invention;

FIG. 2 shows a schematic, cut away side view of the adjusting unit shown in FIG. 1, in the direction of view of the arrow A;

FIG. 3 shows a schematic, partially cut away view of an adjusting unit in accordance with a second exemplary embodiment according to the invention, in a rear top view;

FIG. 4 shows a partially cut away side view of a further adjusting unit in the direction of view of the arrow A in FIGS. 1 and 3; and

FIG. 5 shows a sectional illustration of the adjusting unit shown in FIG. 4, along the line I-I.

### DETAILED DESCRIPTION OF THE PREFERRED EMBODIMENTS

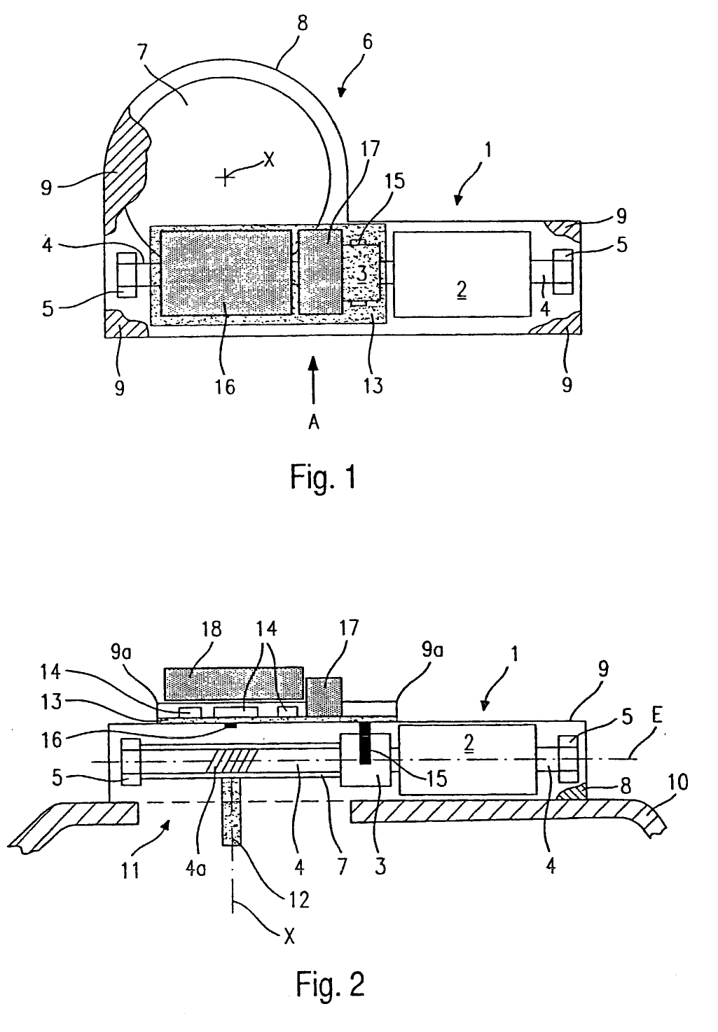

In accordance with FIG. 1, an electromechanical adjusting unit according to the invention includes in accordance with a first exemplary embodiment of the invention an electric motor 1 that is constructed in the usual way from a rotor 2 and a commutator 3 that are connected to one another in a rotationally secure fashion via a shaft 4. The shaft 4 is mounted at its two ends in rotary bearings 5 fixed to the housing.

The electric motor 1 drives a worm gear 6. The shaft 4 is provided for this purpose with a worm thread on a free section between the commutator 3 and the bearing 5 remote from the motor. The worm thread 4a engages in a circumferential toothing of an adjacently arranged worm wheel 7 in the shape of a circular disc, a rotation of the shaft 4 causing a rotary movement of the worm wheel 7 about its axis of rotation X.

The electric motor 1 and the worm gear 6 are accommodated in a housing of which it is possible to recognize in FIG. 1 the outline of the housing side wall 8 and the remainder of the housing base 9, which is cut away for the purposes of illustration.

In accordance with FIG. 2, the adjusting unit can be accommodated directly on the housing wall 10 of a power divider. In the region of the axis of rotation X, the housing wall 10 has an opening or bushing 11 through which a drive shaft 12 of the worm gear 6 projects. The drive shaft 12 transmits a rotation of the worm wheel 7 to a shift position mechanism (not illustrated) inside the power divider. The shift position mechanism of the power divider can be implemented in multifarious ways. For example, it is possible to provide a notched disc that is rotated by the drive shaft 12 and on which there is fitted a lever arm that is displaced to and fro by a rotation of the notched disc. Clutches are opened and closed, respectively, by the displacement of the lever arm via displacement sheets, as a result of which specific shift positions are fixed in the power divider. Possible shift positions are, for example, 2WD (2-wheel drive, corresponds to the standard setting), N (neutral position, that is to say no division of torque between the front and rear axles), 4H (4-wheel drive) and 4L (4-wheel drive with intermediate transmission additionally connected).

In addition to the mechanical and electromechanical components, the adjusting unit is equipped with local electronic and sensor systems. The central element of this local electronic system is a circuit support 13. The circuit support 13 is fitted with electronic components 14, also including a microprocessor, which form an electronic circuit for controlling the electric motor 1. Since the aim is for all the modules of the adjusting unit and, in particular, the electronic system and the sensor system to be integrated to the highest possible degree, the type, configuration and position of the circuit support 13 is of particular significance. This dictates which further components can be fitted on the circuit support 13, and this in turn influences which functions of the control can be implemented easily and cost-effectively.

In accordance with the first exemplary embodiment (FIGS. 1 and 2), the circuit support 13 is of rectangular shape, its long sides being oriented parallel to the shaft 4. The circuit support 13 is situated substantially parallel to a plane E that is defined by the worm gear 6. In this case, the circuit support 13 covers the commutator 3 with an end section facing the electric motor 1, and covers the region of engagement of the work gear 6 and an edge section of the worm wheel 7 with a central section.

The result of this, on the one hand, is that commutator contacts 15 of the electric motor 1 can be fitted on the circuit support 13. This allows all the components for driving the electric motor (for example microprocessor-controlled motor drive circuit, current measuring device, associated supply leads) to be constructed entirely on the circuit support 13.

On the other hand, this design renders it possible to measure the angle of rotation of the worm gear 7 owing to the fitting of a sensor 16, for example a Hall sensor, on the side of the circuit support 13 facing the work gear 6. The sensor 16 can be arranged for this purpose, for example, immediately adjacent to the circumferential toothing of the worm wheel 7, thus rendering incremental determination of rotational angle via the tooth contour of the worm wheel 7. Another possibility consists in arranging the sensor 16 in a region inside the worm wheel circumference and applying markings to the worm wheel 7 that run past the sensor 16 during a rotation of the worm wheel 7.

The sensor 16 can be connected electrically to the microprocessor via conductor tracks and bushing contacts. This microprocessor undertakes an evaluation of the sensor signals received and outputs control signals that serve to drive the motor drive circuit, for example an H-bridge motor drive. In this case, the microprocessor can take account of further parameters that are supplied, for example, by further sensors integrated in the adjusting unit, or are communicated in the form of external data by an integrated motor vehicle network (for example CAN or J1850) connected to the adjusting unit.

The electric connection of the adjusting unit to the motor vehicle periphery (data network, power supply control lamp signals, shift signals, rotational speed signals, etc.) can be accomplished via a single device plug 17. As shown in FIGS. 1 and 2, the latter can be fitted directly on the top side of the circuit support 13, it being possible for the distribution of signals and power supply, internal to the unit, to be performed exclusively on the circuit support 13.

A cooler comprising an aluminum body 18 that is a good conductor of heat, for example, can be fitted above the electronic components 14. For this purpose, the housing base 9 can comprise a projection 9a onto whose outer side the aluminum body 18 is fastened and which bounds on the inside with the circuit support 13 a flat chamber in which at least the power components of the electronic circuit are accommodated.

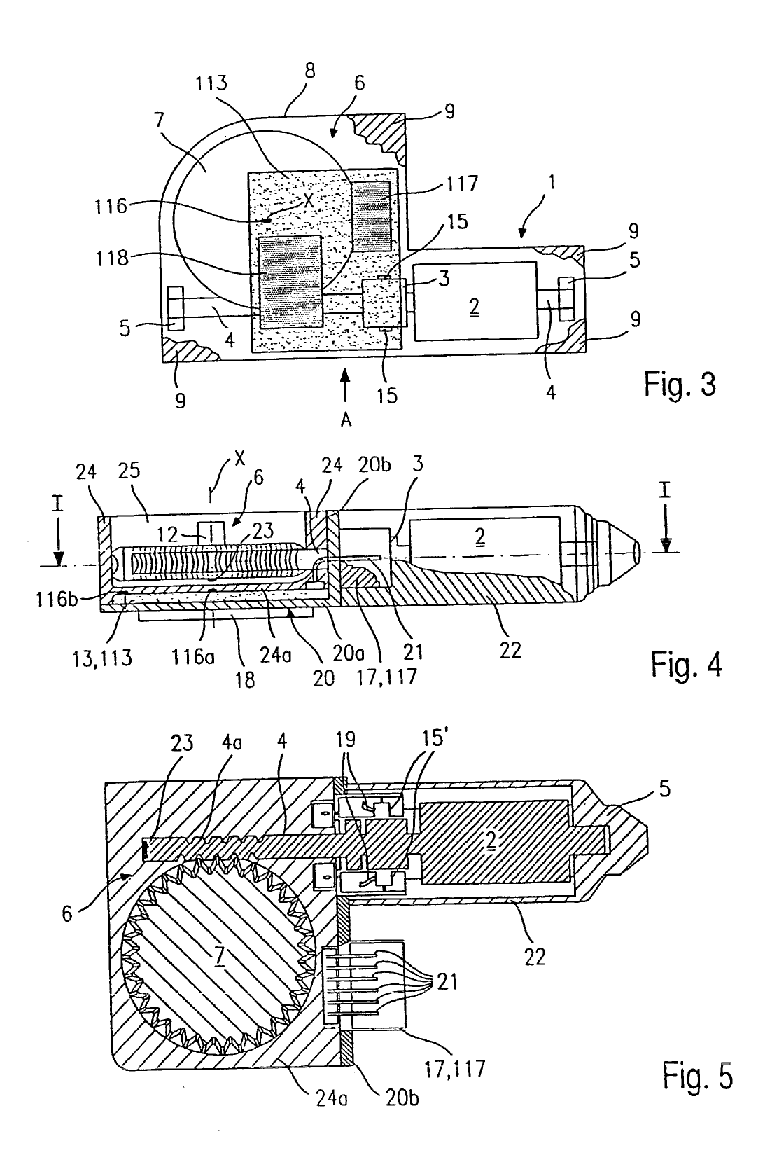

FIG. 3 shows a partially cut away rear view of a second exemplary embodiment of an electromechanical adjusting unit according to the invention. The adjusting unit illustrated in FIG. 3 is substantially of the same design as the adjusting unit according to the first exemplary embodiment with reference to the design and arrangement of the mechanical and electromechanical components 6, 1 but differs from the latter with reference to the design of the circuit support 113 and, if appropriate, with reference to the shape of the housing 8, 9.

The circuit support 113 is likewise of rectangular cut, but is of widened overall size by comparison with the circuit support 13. The circuit support 113 likewise runs parallel to the plane E, but is oriented transverse to the shaft 4 in the longitudinal direction. The commutator contacts 15 and the electronic circuit, which is located below a cooling body 118, are fitted on the circuit support 113 in the way already described. Owing to the increased overall size of the circuit support 113, there is more space available for the electronic circuit, but at the same time there is a need in the region to the side of the commutator 3 to enlarge the housing 8, 9 of the adjusting unit in order to be able to accommodate the circuit support 113 in the housing.

An advantage of the arrangement shown in FIG. 3 consists in that it is now possible to fit a sensor, for example a GMR sensor 116, on the underside of the circuit support 113 above the axis of rotation X of the worm wheel 7. Given central fitting of a magnet on the worm wheel 7, the GMR sensor 116 enables a measurement of absolute angle that is preferred by comparison with the incremental determination of an angle of rotation, because a definition and for example after switching off the power supply of the motor vehicle—refinding of a zero position are eliminated.

A further advantage of the variant illustrated in FIG. 3 consists in that it is possible to use cost-effective circuit supports, for example FR4 printed circuit boards, owing to the widening of the overall size. By contrast, should the available installation space not suffice to implement the electronic circuit on an FR4 printed circuit board, the circuit can be constructed on an LTCC substrate, a flexible printed circuit board or a combination of printed circuit boards.

A device plug 117 fitted on the top side of the circuit support 113 can likewise be designed with a greater overall size than the device plug 17 in the case of the first exemplary embodiment.

Further details and structural variants of the exemplary embodiments discussed above are explained with the aid of FIGS. 4 and 5. In accordance with the partially cut away side view of an adjusting unit shown in FIG. 4, the circuit support 13, 113 can also be dimensioned such that it does not cover the commutator 3. In this case, the commutator contacts 15 make contact with electric leads 19 that are led to corresponding conductor pads (not illustrated) on the circuit support 13, 113.

The device plug 17, 117 can be fastened in a cutout in an aluminum angle element 20 which acts as a stiffening part and whose one limb 20a forms the base of the housing 9 and whose other limb 20b includes the holding opening for the device plug 17, 117. A separate cylindrical housing 22 that is mounted laterally on the limb 20b next to the device plug 17, 117 can be provided for the purpose of holding the electric motor 1.

The circuit support 13, 113 is a conventional, rigid printed circuit board. As described above, however, it is also possible to use a combination of a rigid and a flexible printed circuit board, or a completely flexible printed circuit board. As shown in FIG. 4, the printed circuit board can be fitted with the entire area of its top side on the limb 20a of the angle element, for example laminated on (flexible printed circuit board). In this case, all electric components (sensor system, electronic circuit, plug pins 21, leads 19 or, if appropriate, commutator contacts 15) are located on the underside of the printed circuit board.

In the design illustrated in FIGS. 4 and 5, the sensor system comprises two GMR sensors 116a and 116b, one GMR sensor 116a being arranged, just like the sensor 116 shown in FIG. 3, axially centrally over the worm wheel 7, while the other GMR sensor 116b is positioned adjacent to the end of the shaft 4 remote from the motor. A bar-shaped permanent magnet 23, integrated in the end surface of the shaft 4, with positive and negative poles causes during the rotation of the shaft 4 a magnetic field whose direction changes and whose instantaneous direction is continuously detected by the GMR sensor 116b and communicated to the electronic circuit. It is possible as a result to implement an absolute determination of angle and, in particular, also a measurement of the rotational speed of the shaft 4.

In order to mount the adjusting unit, the first step is to prefabricate the circuit support 13, 113 as a complete module together with the components mounted thereupon (electronic circuit, sensor system, plug pins 21, leads 19 or commutator contacts 15). This module that can be implemented cost-effectively is then inserted into the angle element 20 taking account of the plug cutout.

Thereafter, a plastic injection-molded housing 24 is inserted into the angle element 20. The injection-molded housing 24 has a holding space 25 for the actuating gear 6, and is formed with a continuous intermediate plate 24a that partitions the holding space 25 off from the electric module and thereby protects the latter from lubricants, mechanical wear and the like.

Subsequently, the shaft 4 of the rotor 2 is pushed through an opening in the injection-molded housing 24 and an opening, situated therebehind, in the limb 20b of the angle element 20, until the commutator 3 latches between the commutator contacts 15′. The cylindrical housing 22 is now pushed over the rotor 2 and fixed on the limb 20b. Finally, the worm wheel 7 is inserted into the holding space 25 in the injection-molded housing 24.

All exemplary embodiments and design variants are comparable, and always permit the implementation of an independent device unit with integrated sensor system and a minimum of electric lead cables (for example, only power supply lines and data lines).

1. An electromechanical adjusting unit for setting the shift positions of a transmission, which comprises:
an electromechanical drive,
an actuating gear, driven by the electromechanical drive, with a mechanical output for influencing the shift positions of the transmission,
a circuit support on which an electronic circuit is implemented for controlling the electromechanical drive, and
a sensor means, electrically connected to the electronic circuit, for detecting a movement variable of the actuating gear,
wherein the actuating gear is a worm gear, and
the circuit support extends substantially parallel to the center plane of a worm wheel of the worm gear.

2. The electromechanical adjusting unit as claimed in claim 1, wherein
the commutator contacts for the electromechanical drive are mounted on the circuit support.

3. An electromechanical adjusting unit for setting the shift positions of a transmission, which comprises:
an electromechanical drive,
an actuating gear, driven by the electromechanical drive, with a mechanical output for influencing the shift positions of the transmission,
a circuit support on which an electronic circuit is implemented for controlling the electromechanical drive, and
a sensor means, electrically connected to the electronic circuit, for detecting a movement variable of the actuating gear, and wherein
the commutator contacts for the electromechanical drive are mounted on the circuit support.

4. The electromechanical adjusting unit as claimed in claim 3, wherein
the actuating gear is a worm gear, and wherein
the circuit support extends substantially parallel to the center plane of a worm wheel of the worm gear.

5. The electromechanical adjusting unit as claimed in claim 1, wherein
the sensor means is mounted on the circuit support.

6. The electromechanical adjusting unit as claimed in claim 1, wherein
a plug connector element is mounted on the circuit support in order to connect the electromechanical adjusting unit to an electrical motor vehicle periphery.

7. The electromechanical adjusting unit as claimed in claim 1, wherein
the circuit support is dimensioned such that it covers no more than an edge region of the worm wheel, and
in that a first sensor, in particular a Hall sensor, is fitted on the circuit support in this region in order to detect a rotary movement of the worm wheel.

8. The electromechanical adjusting unit as claimed in claim 1, wherein
the circuit support is dimensioned such that it covers the center of the worm wheel, and
a second sensor, in particular a GMR sensor, is fitted on the circuit support in a region neighboring the worm wheel center in order to detect an absolute rotational angle position of the worm wheel.

9. The electromechanical adjusting unit as claimed in claim 1, wherein
the circuit support is dimensioned such that it covers that end of a worm shaft of the worm gear which is remote from the drive, and
a third sensor, in particular a GMR sensor, is fitted on the circuit support in this region in order to detect a rotary movement of the worm shaft.

10. The electromechanical adjusting unit as claimed in claim 1, wherein
the actuating gear has a shaft with a permanent magnet that has opposite poles in order to generate a changing magnetic field as the shaft rotates.

11. The electromechanical adjusting unit as claimed in claim 1, wherein
the circuit support is accommodated in a housing space partitioned off from the actuating gear.

12. The electromechanical adjusting unit as claimed in claim 10, wherein
the circuit support is a rigid printed circuit board.

13. The electromechanical adjusting unit as claimed in claim 1, wherein
the circuit support is a flexible printed circuit board bonded at least over part of the surface onto a metallic support.

14. The electromechanical adjusting unit as claimed in claim 1, wherein
the gear is a power divider.

15. The electromechanical adjusting unit as claimed in claim 1, wherein
the gear is a motor vehicle transmission.

16. The electromechanical adjusting unit as claimed in claim 3, wherein
the sensor means is mounted on the circuit support.

17. The electromechanical adjusting unit as claimed in claim 3, wherein
a plug connector element is mounted on the circuit support in order to connect the electromechanical adjusting unit to an electrical motor vehicle periphery.

18. The electromechanical adjusting unit as claimed in claim 3, wherein
the actuating gear has a shaft with a permanent magnet that has opposite poles in order to generate a changing magnetic field as the shaft rotates.

19. The electromechanical adjusting unit as claimed in claim 3, wherein
the circuit support is accommodated in a housing space partitioned off from the actuating gear.

20. The electromechanical adjusting unit as claimed in claim 3, wherein
the circuit support is a flexible printed circuit board bonded at least over part of the surface onto a metallic support.

21. The electromechanical adjusting unit as claimed in claim 3, wherein
the gear is a power divider.

22. The electromechanical adjusting unit as claimed in claim 3, wherein
the gear is a motor vehicle transmission.
